(19) United States
(12) Patent Application Publication
(10) Pub. No.: US 2017/0185612 A1
(43) Pub. Date: Jun. 29, 2017

(54) DYNAMICALLY DESIGNING WEB PAGES

(71) Applicant: SuccessFactors, Inc., South San Francisco, CA (US)

(72) Inventors: SUNIL KAMADOLLI, Sunnyvale, CA (US); PRASHANT KUMAR, Millbrae, CA (US); MUGE DAS, Redwood City, CA (US); RAJAT KARNWAL, Dublin, CA (US); PAIGE CHERNY, Redmond, CA (US); SHARON LAU, San Mateo, CA (US); ABHINAV GUPTA, San Francisco, CA (US); CORA SCHOPPE, South San Francisco, CA (US); JASON KOLAITIS, Reston, VA (US)

(21) Appl. No.: 14/981,909

(22) Filed: Dec. 29, 2015

(51) Int. Cl. G06F 17/30; G06F 17/21; H04L 29/06; G06F 3/0484; G06F 3/0481

(52) U.S. Cl. CPC G06F 17/3089; G06F 3/04842; G06F 3/0481; H04L 63/20; G06F 17/212

(57) ABSTRACT

Various embodiments of systems, computer program products, and methods for dynamically designing webpages are described herein. In an aspect, a request for designing a webpage may be received. Based upon the request, a metadata related to the webpage may be identified. Based upon the identified metadata, one or more widgets for designing the webpage may be rendered. A selection of a widget from the one or more widgets may be received from a user. Multiple sections of the webpage and the widgets positioned in corresponding sections may be identified. The identified widgets of the webpage may be integrated with one or more security rules.

### TECHNICAL FIELD

The field generally relates to designing web pages.

### BACKGROUND

A webpage is a hypertext markup language (HTML) document on the World Wide Web which includes text, graphics, audio, and/or video, etc. Usually, a solution package includes webpages designed and packaged for a specific business process. For example, a recruitment management solution package includes webpages designed and packaged for a recruitment process. The solution package is provided by vendors. Different customers have different design and content requirement(s) for the same business process. Customers may need to contact the vendor to edit or customize webpage(s) within the solution package. Contacting vendors and customizing webpages may be an arduous and a time consuming task specifically when the solution package is provided as cloud deployment. Moreover, the customers are restricted to static design of the webpages within the solution package and cannot experiment, modify, or flexibly enhance layout of the webpages by themselves.

### SUMMARY

Various embodiments of systems, computer program products, and methods for dynamically designing webpages are described herein. In an aspect, a request for designing a webpage is received. Based upon the request, a metadata related to the webpage is identified. Based upon the identified metadata, one or more widgets for designing the webpage is rendered. A selection of a widget from the one or more widgets is received from a user. Multiple sections of the webpage and the widgets positioned in corresponding sections are identified. The identified widgets of the webpage are integrated with one or more security rules.

The above methods, apparatus, and computer program products may, in some implementations, further include one or more of the following features.

One or more widgets may be stored in a widget library.

The multiple sections may include a header, a footer, and a body of the webpage.

The metadata may define a business process related to the webpage.

A request for rendering the webpage may be received. A context related to the webpage may be identified Based upon the context, the one or more security rules to be applied on the webpage may be identified. Based upon the identified one or more security rules, a layout for rendering the webpage may be dynamically generated. Based upon the generated layout, the webpage may be rendered.

The context may include one or more of a log-in information of a user accessing the webpage, a business role or a designation of the user accessing the webpage, a business process for which the webpage is created, and a business process state.

An action performed on the webpage may be identified. Based upon the action, an event may be generated and one or more widgets to be updated in the webpage may be identified. The generated event may be sent to the identified one or more widgets. The one or more widgets may update its data upon receiving the event.

The action may include one of addition of data, deletion of data, updating data, and selection of a user interface component on the webpage.

These and other benefits and features of various embodiments will be apparent upon consideration of the following detailed description of embodiments thereof, presented in connection with the following drawings.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram illustrating an exemplary webpage designing environment, according to an embodiment.

FIG. 2 illustrates an exemplary webpage including various widgets, according to an embodiment.

FIG. 3 is a block diagram illustrating a page layout tool connected to a user interface (UI) engine and a backend engine for rendering a webpage at runtime, according to an embodiment.

FIG. 4 is a dataflow diagram for rendering the webpage at runtime, according to an embodiment.

FIG. 5 illustrates a user interface (UI) engine coupled to a page layout controller for rendering the webpage, according to an embodiment.

FIGS. 6A-6B illustrate an event handler handling interaction or events between a header and a body section of the webpage, according to an embodiment.

FIG. 6C illustrates the event handler handling interaction between a footer and the body section of the webpage, according to an embodiment.

FIG. 7 is a flowchart illustrating a process of dynamically designing webpages within a solution package, according to an embodiment.

FIG. 8 is a flowchart illustrating a process of rendering a webpage at runtime, according to an embodiment.

FIG. 9 is a block diagram illustrating an exemplary computer system, according to an embodiment.

Like reference symbols in the various drawings indicate like elements.

### DETAILED DESCRIPTION

Embodiments of techniques for dynamically designing webpages within a solution package are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

“Entity” or “object” refers to a “thing of interest” for which data is to be collected. For example, an entity may be a customer, an employee, a candidate, an offer letter, an item of stock, a sales order, a purchase order, etc. The entity may be related to a business process. For example, the entity “candidate” may be related to the business process “recruitment management (RCM).” The entity comprises one or more attributes or properties that characterize one or more features of the entity. For example, the entity “customer” or “candidate” may comprise attributes such as name, age, sex, nationality, etc.

“Business process” refers to a set of linked procedures or activities which are collectively executed (in series or parallel) to realize a business objective or goal. For example, a business process “recruitment management” (RCM) may comprise three linked procedure namely “requisition creation,” “requisition preparation,” and “approval” which are executed in series to realize “recruitment” process. At any point of time the business process may be a distinct procedure or step. A current procedure or a step of the business process at any instance of time is referred as “business process state”. “Requisition creation”, “requisition preparation,” and “approval” are three states of the business process “RCM.”

“Business application” or “solution package” refers to a software program which is used to execute a business process, i.e., perform the procedures or steps of the business process. The business application may be an “on premise” application or may be provided as “on-cloud” solution. The business application may be interactive and includes one or more graphical user interfaces (GUIs). A user can query, modify, and input data and analyze results instantaneously though the one or more GUIs. A graphical user interface (GUI) of the business application comprises a webpage.

“Webpage” refers to a web document, e.g., hypertext markup language (HTML) document, on the World Wide Web. A webpage may comprise at least one of text, graphics, animation, video, audio, etc. The webpage may be designed according to a specific business process or requirement. Typically, the webpage is classified into one or more sections including, for example, a header, a footer, and a body or content. The header may include a broad and an abstract level information related to the webpage, the footer may include concluder elements such as a save button, a cancel button, a continue button (to go to next webpage), etc. The body may include various information related to the business process for which the webpage is designed and fields for receiving user's input. In an embodiment, the body may comprise multiple sections for receiving input or information related to the business process. For example, the body of the webpage related to the recruitment management may comprise sections such as “requisition information,” “position information,” “organization information,” “location information.” “personal information,” etc. In an embodiment, the body may include one or more configurable and/or non-configurable UI portlets. Portlets refer to pluggable UI components displayed in a web or an enterprise-portals. The non-configurable UI portlets have fixed code and cannot be edited such as non-configurable webpage images, videos, etc. The header, the footer, and the body of the webpage may comprise one or more widgets.

“Widget” refers to an application or a component of an interface, which enables a user to perform a function or access a service. Widgets are displayed in the graphical user interface (GUI), e.g., as a button, a scroll bar, labels, and check boxes, etc. The widgets are configured or defined by developers or vendors and stored in a widget library. Widgets may be configured based upon the business process in which it is used. For example, for recruitment management (RCM), widgets such as “action button” widget, “insight” widget, “prepare requisition” widget, “candidate source analysis” widget. “field missing” widget, “customizable field summary” widget, “business process progress” widget, “action link” widget, “configuration UI form” widget, etc., may be configured or used. Some widgets are universal which may be deployed or used in multiple business processes/applications. For example, “insight” widget, “action button” widget, “fields missing” widget, “business process” widget, etc., are generic widgets. Some widgets are specific to the business process. For example, widgets such as “prepare requisition” and “candidate source analysis” are specific to recruitment management (RCM).

“Action button” widget may include various buttons like save, cancel, submit, etc. “Insight” widget may provide detailed or insight information related to an entity in context, e.g. if the entity is “requisition”, the “insight” widgets can be configured to provide information like “average salary offered for similar position,” etc. “Prepare requisition” widget may enable editing or additional inclusion of data to an already created “requisition.” “Candidate source analysis” widget is enabled to provides a chart showing a source from where a candidate is recruited (e.g., percentage of applicant from different sources) such as 30% candidates from/through internal referral, 20% from job boards, and 30% from agency sourcing etc. “Customizable field summary” widget may render different fields based on the entity in context. The “customizable field summary” widget is enabled to be customized for displaying different number of fields for different entity. “Field missing” widget may be enabled to display the number of fields (e.g., essential fields in the body) which do not contain any data or value, i.e., have missing value. “Business process progress” widget may be enabled to display graphical view of the business process and indicates a current state of the business process. “Action link” widget may be a collapsible widget which is enabled to contain various clickable icons. The icons may be mapped to different actions which may be triggered on click of the icons, e.g., when “create notes” icon is clicked, it opens up an editor through which notes can be entered. “Configuration UI form” widget may be enabled to provide a “configurable form” which includes fields for receiving data from a user. The “configuration form” is a specific instance of “configurable UI form” widget. “Customizable field summary” widget may be enabled to contain fields specific to the entity for which the webpage is created. For example, if the entity is “requisition,” then the “customizable field summary” widgets may include fields, e.g., requisition-name, location, department, position #, etc. Similarly, if the entity is “candidate” then the “customizable field summary” widgets may include fields like candidate's first name, email, address, phone #, eligible_for_interview, etc. “Customizable field summary” widget may have different number of fields based on configurations. For some pages (configuration) there may be 4 fields in “customizable field summary” and for some pages there may be 8 fields. Therefore, the type of fields and number of fields may be customized.

“Page designer tool” or “page layout tool” refers to a tool for designing webpages. The page layout tool may include predefined widgets which can be used for designing webpages. For example, different widgets may be used for designing the header, the footer, and the body or content of a webpage. The page layout tool may also be communicatively coupled to various rule engines to apply predefined rules or security rules on the designed webpages. Typically, the predefined rules or security rules are applied while rendering the webpage at runtime. The rules may be related to a profile or a role of a user accessing the webpage, the business process for which the webpage is designed, the entity related to the webpage, the business process state, etc. For example, there may be multiple job profiles (i.e., roles) in an organization such as an executive (Tier 1), a manager (Tier 2), and a chief executive officer (Tier 3). The rule related to the job profile or role of the user, may be: if <role>=“Tier 1” then hide “customizable field summary” widget. An example of the rule related to the business process may be: if <business process>=RCM, then display “prepare requisition” and “candidate source analysis” widget. Similarly, the rule related to the entity (e.g., candidate in RCM) may be: if <candidate's date of birth> is ≦“16 years”, the populate field “eligible_for_interview” in the “customizable field summary” widgets as “not eligible.” The page layout tool may also be referred as an “administrator page.”

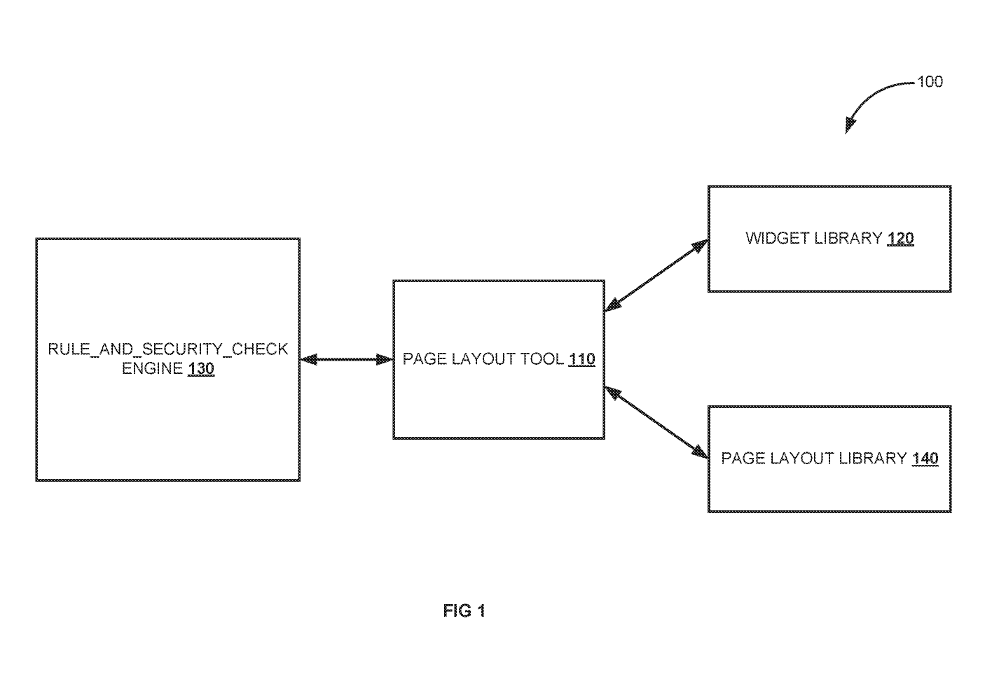

FIG. 1 is a block diagram illustrating exemplary webpage designing environment 100. The webpage designing environment 100 may include a page layout tool 110 for designing webpages. A request for designing the webpage may be received by the page layout tool 110. In an embodiment, the request may be received through a command provided by a user, e.g., by clicking an icon. Upon receiving the request, the page layout tool 110 identifies a metadata for which the webpage is to be designed. In an embodiment, the metadata may be a business process for which the webpage is to be designed. Once the metadata is identified, the page layout tool 110 renders or provides one or more widgets which can be used to design the webpage. The page layout tool 110 may be communicatively coupled to a widget library 120. The widget library 120 may include one or more predefined widgets which can be used for designing webpages. In an embodiment, the widget(s) which are relevant for the identified metadata (e.g., the business process) are rendered in the widget library 120. A widget can be selected from the widget library 120. The selected widget can be positioned on the webpage using any suitable user interface (UI) operation such as drag-&-drop. Various sections of the webpage such as a header, a footer, and a body may be configured or designed using the one or more widgets from the widget library 120. For example, the widgets such as “insight”. “fields missing,” and “prepare requisition” may be positioned or used in the header section, “action button” widget may be positioned or used in the footer section, and “configuration UI form” widget may be positioned or used in the body of the webpage related to the recruitment management (RCM). In an embodiment, the one or more widgets may be automatically populated on the webpage or on the required section of the webpage based on a pre-defined logic. Some of the widgets are essential or mandatory and may not be removed or deleted from the webpage. For example, a “field summary widget” and “configuration UI form” widget may be essential widgets which may not be removed in case of the RCM webpage.

Once the widgets are positioned on the webpage, the page layout tool 110 integrates the widgets to their corresponding section. The page layout tool 110 also integrates the widgets to various predefined rules or security rules. In an embodiment, the predefined rules may be integrated to the widgets. In an embodiment, integrate may refer to one of a configure and an apply operation. There may be a predefined rule R1 defined as {R1=“disable widgets when working in an offline mode”} and there may be widgets W1 and W2. In an embodiment, integrating the predefined rule R1 to the widgets W1 and W2 may imply “applying” predefined rule R1 to the widgets W1 and W2 as {APPLY R1 to widgets W1 and W2}. “APPLY” may be a logical operation to link the predefined rule R1 to the widgets W1 and W2 so that the widgets W1 and W2 are rendered according to the predefined rule R1. Therefore, the widgets W1 and W2 would be disabled whenever the user works in the offline mode. In an embodiment, integrating the predefined rule R1 to the widgets W1 and W2 may imply “configuring” the predefined rule R1 within the widgets W1 and W2 as (CONFIGURE R1 into widgets W1 and W2). A “CONFIGURE” operation may include or embed the predefined rule R1 within code of the widgets W1 and W2 so that the predefined rule R1 becomes a part of the widgets W1 and W2, and the widgets W1 and W2 may be executed according to the embedded predefined rule R1. Based upon the predefined rule(s), the one or more widgets may be hidden, disabled, or displayed differently on the webpage. In an embodiment, the predefined rules may be defined or configured by the user (e.g., customer). The page layout tool 110 is communicatively coupled to a rule_and_security_check engine 130 to apply various rules on the webpage. The rules may be related to the business process, the business process state, a log-in information of the user or role of the user, i.e., widgets to be displayed to the user based upon the user's role in the organization (role based permission or RBP), etc. In an embodiment, the rules may be applied, at runtime, while rendering the webpage.

The rule_and_security_check engine 130 may also include various security checks related to the webpage. The customer or user can define various security checks to be performed while displaying widgets on the webpage, e.g., from where the widgets would retrieve its data, how the widget would behave, what data widget would display based on current state of the business process, what “action button” to be displayed, etc. Based upon the rules and security checks, it may be determined if any feature or widget is enabled or disabled (restricted) for the user or company. In an embodiment, there may be separate rule engine and security check engine.

One the rules are integrated and the webpage is designed, the page layout tool 110 enables customers to save the designed webpage. The designed webpage is saved and stored in a page layout library 140. Therefore, customized webpages may be created and stored in the page layout library 140 for later reuse. The page layout library 140 may store one or more predefined page layouts or webpages (provided by vendors based upon the business process) which can be used directly.

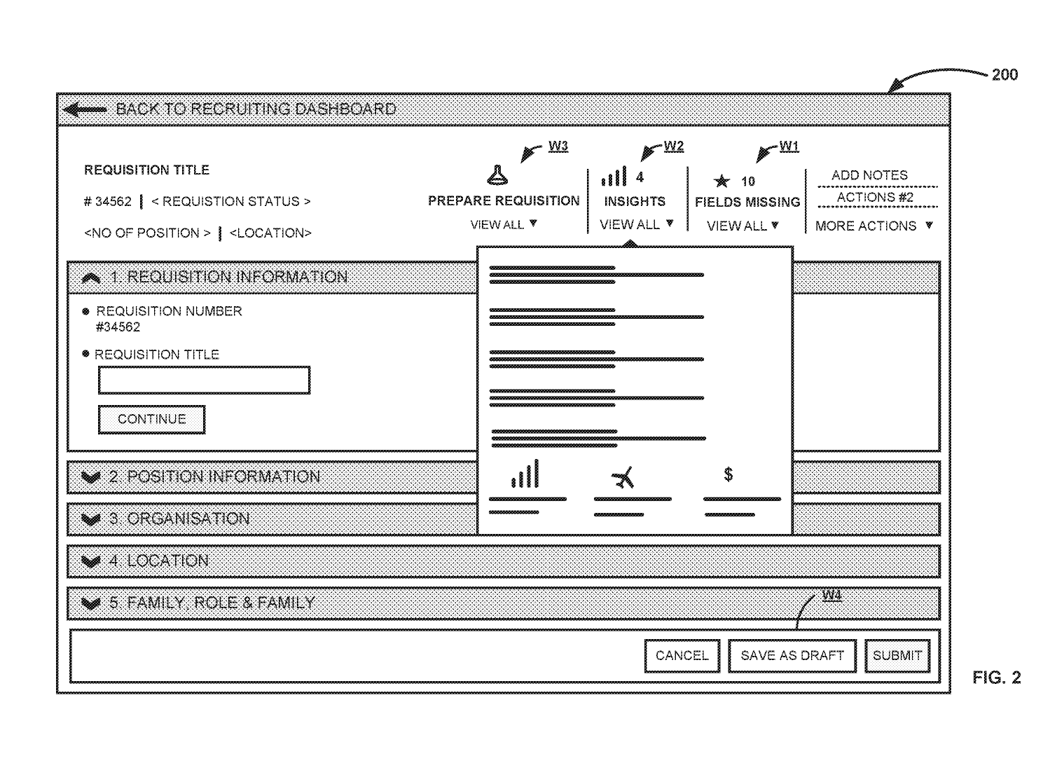

FIG. 2 illustrates an exemplary webpage 200 including widgets, e.g., the widgets W1-W4. The widget W1 in the header is a “fields missing” widget. The “fields missing” widget W1 may display total number of fields (data) missing in the webpage (e.g., in the body or content of the webpage). In an embodiment, the “fields missing” widget W1 may display the total number of mandatory fields for which values are either not provided or are missing. The widget W2 in the header is an “insight” widget that when selected may display additional or detailed information related to the selected section of the body of the webpage. For example, the “insight” widget may display information such as “average salary offered for similar position,” when a “requisition” section is selected in the body of the webpage, etc. The widget W3 in the header is a “prepare requisition” widget which is used to edit information in an already created requisition. The widget W4 is “action button” widget in the footer of the webpage 200. The “action button” widget W4 may include, for example, a cancel button, a save button, a submit button, a form summary data, etc. Once the webpage is created, the widgets (W1-W4) may start interacting with each other. Each widget is provided with a “callback” feature. The callback feature refers to a feature where the widget can be called and its data can be retrieved. In an embodiment, a widget data might be dependent on other widget data and in that case, the widget might call another widget to get its data retrieved.

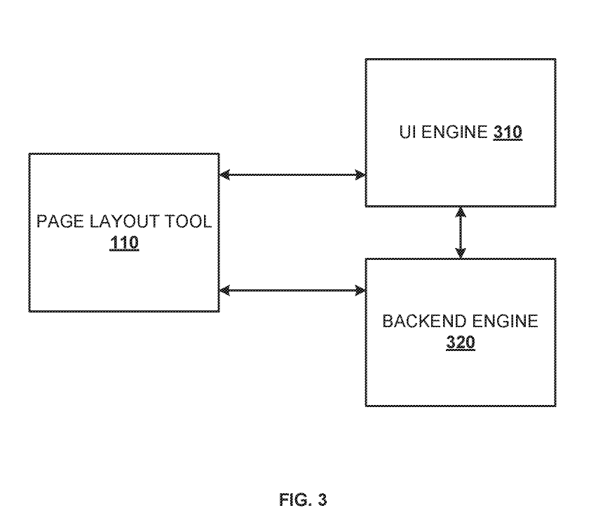

For rendering the webpages (e.g., the webpage 200 of FIG. 2) at runtime, the page layout tool 110 communicates with a user interface (UI) engine 310 (FIG. 3). The UI engine 310 then communicates with a backend engine 320 to retrieve the layout of the webpage to be rendered. In an embodiment, the backend engine 320 retrieves the layout of the webpage from the page layout library 130. In an embodiment, the page layout library 130 may be a part of the backend engine 320. Upon retrieving the layout of the webpage, the widgets related to the layout of the webpage triggers callback service to retrieve its data and apply any rule or filter such as RBP, business process modeling (BMP), etc. In an embodiment, the page layout tool 110 automatically populates respective widgets based on the context of the webpage. The context of the webpage can include, for example, the page the widget is currently in. In an embodiment, the page layout tool 110 may automatically populate respective widgets based on the user, the RBP, state of the business process object, etc. For example, in context of the RCM webpage, a “field summary” widget is populated with “requisition data” and the “insight” widget is populated with “requisition insights.” The UI engine 310 then renders the webpage using retrieved layout and the widgets. In an embodiment, the backend engine 320 and the UI engine 310 may be a part of the page layout tool 110.

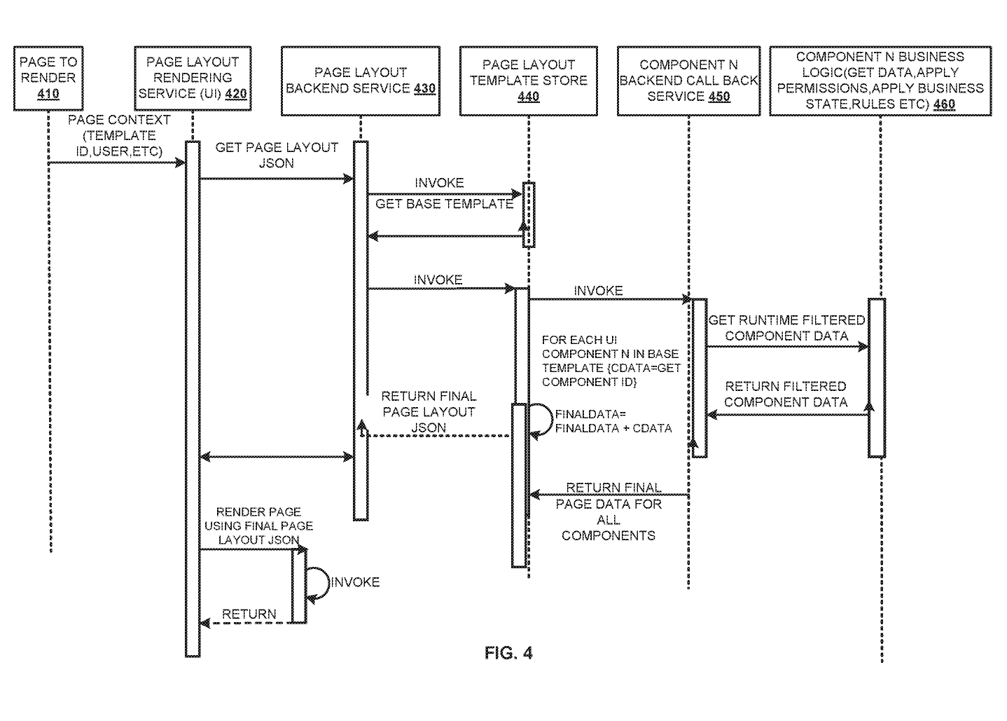

FIG. 4 is a dataflow diagram for rendering a webpage at runtime. At process block 410, a page or webpage that is to be rendered may be identified, e.g., through a command provided by the user. Once the webpage is identified, a UI engine (e.g., the UI engine 310 of FIG. 3) may retrieve information related to page context, such as page template ID, user log-in information, etc. The information may be retrieved from a page layout tool (e.g., the page layout tool 110 of FIG. 1) and/or a backend engine (e.g., the backend engine 320 of FIG. 3). At process block 420, the retrieved information may be provided to a page layout rendering service for rendering the webpage. The page layout rendering service may be a part of the UI engine or may be a separate entity. The page layout rendering service may call a function, such as getpagelayout( ). The function getpagelayout( ) may be called along with the name of the webpage to be rendered, e.g., getpagelayoutJson( ) to retrieve and render the webpage, namely “Json.” In an embodiment, there may be multiple layout configurations for rendering the named webpage. The user (e.g., an administrator) can select any configuration/version for rendering the webpage. When the function getpagelayout( ) is called, a page layout backend service may be invoked at process block 430. The page layout backend service may be a part of the backend engine.

At process block 440, the page layout backend service invokes page layout template store (e.g., the layout library 130 of FIG. 1 or the backend engine 320 of FIG. 3) to retrieve the template of the webpage (Json) using the function gettemplate( ) or getbase template( ), for example. In an embodiment, once the gettemplate( ) is called, the page layout template store invokes each widget (i.e., each UI component) included in the page layout template. Invoking a widget may include invoking a backend callback service. At process block 450, component (widget) backend callback service may be invoked. In an embodiment, the backend callback service may be a part of the backend engine (e.g., the backend engine 320 of FIG. 3). The backend callback service may retrieve data related to each UI component or widget N of the page layout template. For example, the backend callback service may retrieve component data using a “CData” callback. In the implementation of FIG. 4, CData is equal to get component (N) ID, where N is a natural number and is incremented until all components are processed. Therefore, 1≦N≦total number of components. At process block 460, the backend callback service may apply various rules and security checks (e.g., RBP) on each component or widget N which is to be rendered. In an embodiment, the widget itself invokes the backend callback service to implement or apply various rules and security check to retrieve the filtered data to be rendered by the widget.

In an embodiment, the backend callback service may implement a function getRuntimeFilteredComponentData( ) to retrieve filtered data for each component based upon various rules and security checks for corresponding UI component or widget. The filtered component data may be returned to the backend callback service which, in turn, may return final data for the component or widget to the page layout backend service. The above process may be repeated to calculate final data related to all the widgets of the page layout (i.e., final data=CData+final data). The final data of all the widgets may be used to generate a final page layout for the webpage. Once the final page layout including all the widgets is returned to the page layout backend service, the page layout backend service may return the final webpage layout along with all components to the page layout rendering service. The page layout rendering service then renders the webpage using the final page layout.

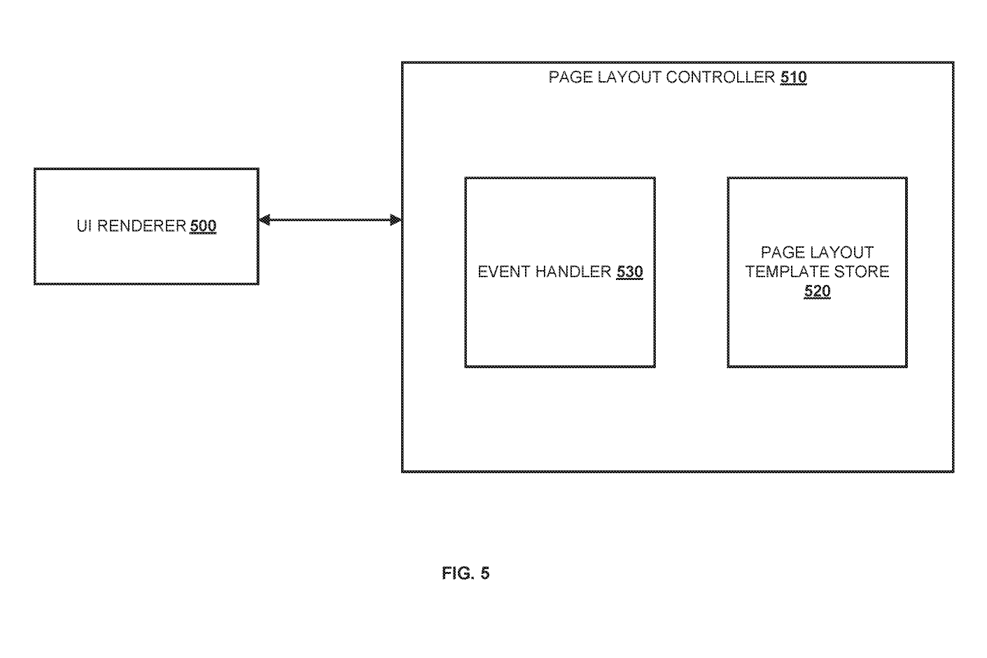

FIG. 5 illustrates a UI renderer 500 coupled to a page layout controller 510 for rendering the webpage based upon the final page layout. In an embodiment, the UI renderer 500 may be a part of the UI engine 310 (FIG. 3), and the page layout controller 510 may be a part of the page layout tool 110 or the backend engine 320. The page layout controller 510 includes an event handler 530 and a page layout template store 520. The page layout controller 510 may manage any change occurring in the webpage, e.g., any action or status change such as field value change, button clicked, data deleted, etc. Page layout controller 510 includes event handler 530 to listen or observe events, action, changes, in the header, the footer, and the body of the webpage and trigger or generate an event accordingly. For example, if the “section name” in “missing field” tile in the header section is clicked, the event handler 530 may trigger a “toggle SectionClicked” event. When “toggle SectionClicked” event is generated or triggered, the page layout controller 510 may open the section which is clicked, and UI renderer 500 may display the open section. The page layout controller 510 has direct access to the sections. In an embodiment, the page layout controller 510 may communicate with the UI renderer 500 for rendering the open or selected section. The UI renderer 500 may retrieve the page layout template of the open section from the page layout template store 520 and may render the selected section. Similarly, for actions such as clicking the footer button (save, cancel, or submit), for example, the event “FooterButtonClicked” may be triggered and save, cancel, or submit action may be performed accordingly.

In an embodiment, if there is any change in the webpage, e.g., any field is updated or modified, any button is selected or clicked, etc., then one or more fields may be updated based on these changes. For example, if any data is removed, then the “missing field” widget in the header may be updated. Once any change occurs, the page layout controller 510 listens to the change (e.g., through an event generated or triggered by the event handler 530). The page layout controller 510 may then retrieve or fetch the details of the change by calling the UI renderer 500 through a method (e.g., “getRequiredFields( )”) to get or retrieve all essential (required) fields. The missing fields may then be counted, and the “missing filed” widget may be updated in the header. Based upon the change, the page layout controller 510 may update the webpage (layout of the webpage) and communicate the changed layout of the webpage to the page layout template store 520 for storing the updated webpage.

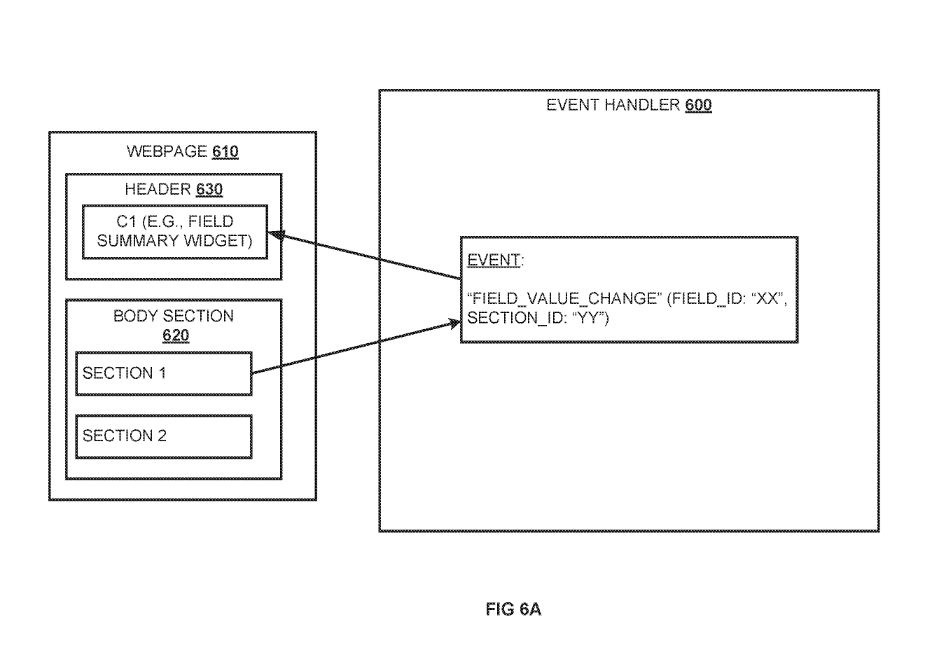

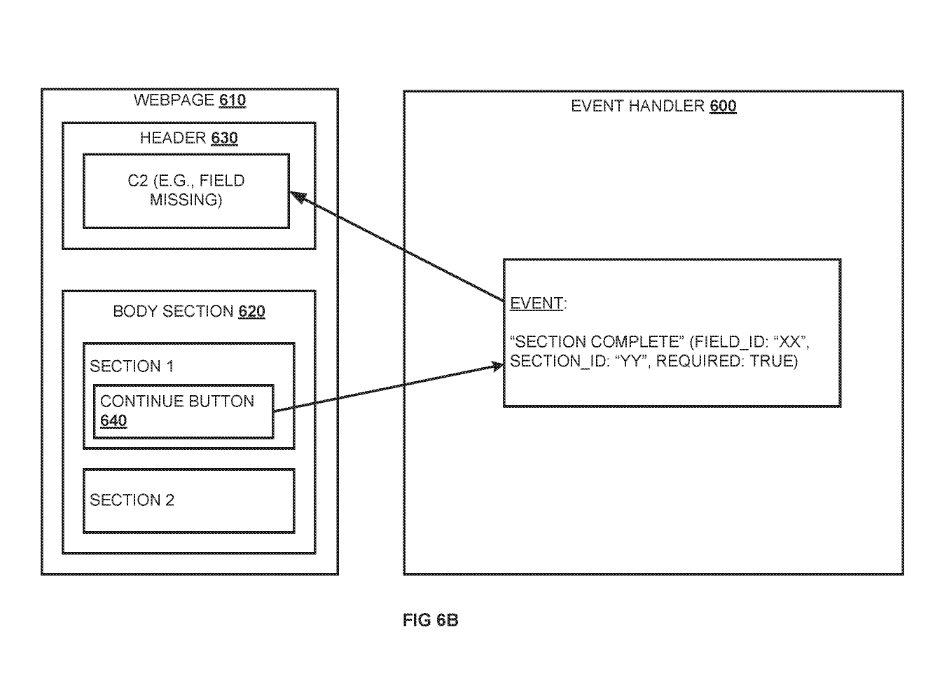

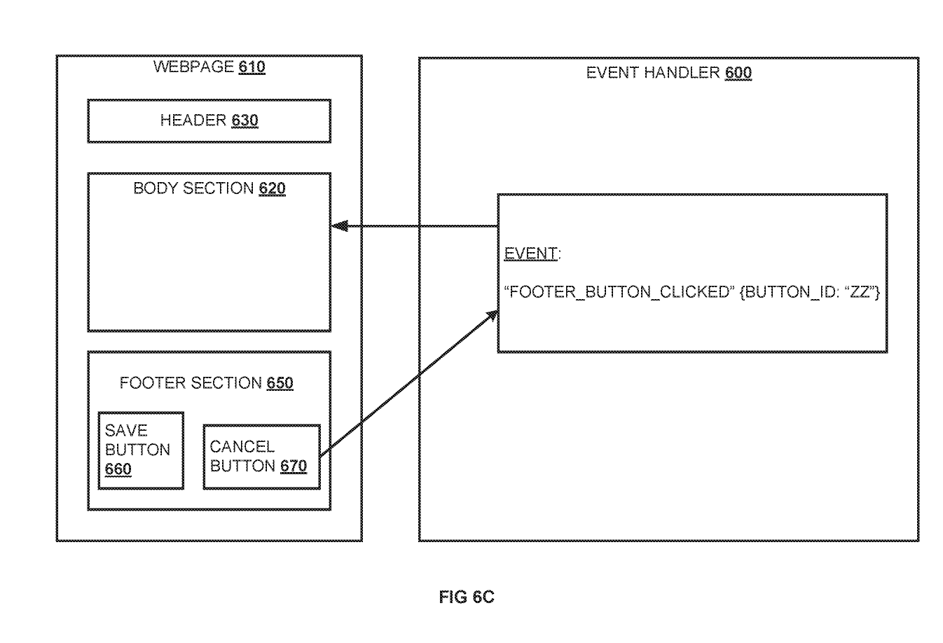

FIG. 6A illustrates an event handler 600 communicatively coupled to a webpage 610 for handling events related to the webpage 610. The webpage 610 may include a body section 620 and a header 630. The body section 620 of the webpage 610 may be a configurable form, i.e., a form which can be filled by the user. Typically, the body section 620 may include one or more sections, e.g., section 1 (including personal information such as user's name), section 2 (including information related to work experience), etc. The header 630 comprises one or more widgets or components, e.g., a field summary widget or component C1. The component C1 (field summary widget) may display a summary of various information (e.g., user's name) included in the body section 620 (section 1). The component C1 (field summary widget) may be updated based upon event(s) occurring in the body section 620 of the webpage 610. For example, when there is any change in any section, such as when the “user name” is changed in section 1 (personal information) of the body section 620, then the widget or component C1 (displaying user's name) in the header 630 may be updated accordingly. When there is any change in the field of the body section 620, the event handler 600 may generate an event “field value change.” The event “field value change” may be in a format {field_ID: “XX”, section_ID: “YY” }. The event format may indicate the field (e.g., user name) and the section (e.g., section 1) of the body section 620 having changed values. The generated event is notified or dispatched to the header 630. The event is notified to the components or widgets affected by the event. For example, the event handler 600 may notify the component C1 (field summary widget) about the change (e.g., name change) in the section 1 of the body section 620 through the event. Once the event is received by the component C1, the component C1 may render itself with the updated data. In an embodiment, the component C1 may call a backend engine to get updated with the changed data (e.g., new or updated user name), based upon the event.

FIG. 6B illustrates the event handler 600 handling another event related to the body section 620 of the webpage 610. Section 1 (which can contain personal information, such as a user's name) of body section 620 may include a “continue button” 640. When the continue button 640 is selected or clicked, the information included in the body section 620 may be saved, and the user may move to the next section, e.g., section 2. In an embodiment, when the continue button 640 is selected, the event handler 600 may generate an event “section complete” to indicate that the information in section 1 is completed. The event handler 600 may notify the generated event “section complete” to the components or widgets which, in turn, may be updated based on this event. For example, a component C2 (field missing widget) in the header 630 may be notified about the “section complete” event. The event may be in format {field_ID: “XX”, section_ID: “YY”, required: TRUE}. The event may indicate the section which is completed, the field which is completed, and whether the completed field is an “essential” field of the webpage 610. In an embodiment, once the continue button 640 is selected, the event may be generated indicating all the fields (field_IDs) included in the completed section (section 1), and the fields which are “essential”, if any. The generated event may be sent or dispatched to the header 630. For example, the generated event may be sent to the “field missing” widget or component C2 of the header 630. The component C2 may then be updated. For example, the essential or field(s) whose value is missing may be counted and listed in the component C2.

When the component C2 is clicked or selected in the header 630, the “missing field” (essential fields which have missing values) may be listed or displayed. The fields are listed under their respective section name or heading. For example, when the “name” field in the section 1 has a missing value, then the “name” field may be displayed under the section 1 in the list of missing fields. In an embodiment, when the section 1 is selected from the list of missing fields, the event handler 600 again generates another event which is communicated to the section 1 of the body section 620. The section 1 may then communicate with the UI renderer 500 (FIG. 5). The UI renderer 500 may finally render section 1, e.g., by highlighting one or more missing fields (e.g., user name) of the section 1.

FIG. 6C illustrates the event handler 600 handling another event related to a footer section 650 of the webpage 610. The footer section 650 may include a save button 660 and a cancel button 670. When the save button 660 or the cancel button 670 is selected or clicked in the footer section 650, the event handler 600 may generate an event, such as “footer_button_clicked”. The event may be of format {button_ID} indicating the button which is selected or clicked. The generated event is sent or dispatched to the body section 620. Based upon the event, the body section 620 may call a backend function to perform the necessary action, e.g., save or cancel.

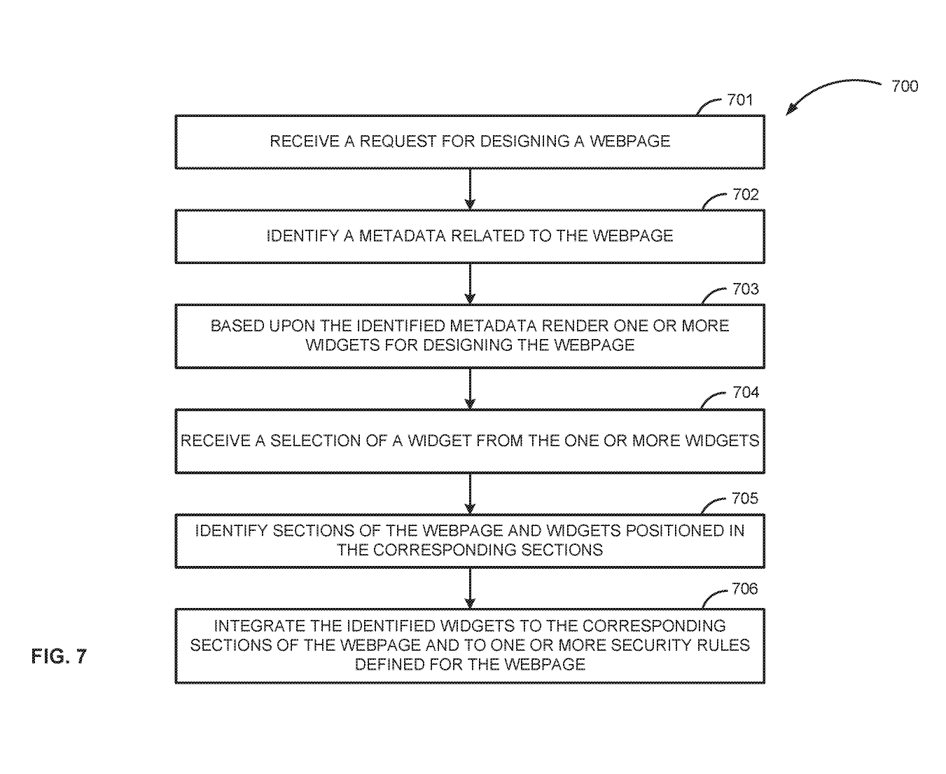

FIG. 7 is a flowchart illustrating process 700 to dynamically design a webpage within a solution package. At 701, a page layout tool (e.g., the page layout tool 110 of FIG. 1) may receive a request for designing a webpage through a command (e.g., by click of an icon). Once a request is received, the page layout tool 110 may identify a metadata related to the webpage at 702. In an embodiment, the metadata may be a business process for which the webpage is to be designed. Based upon the identified metadata, the page layout tool may render one or more widgets for designing the webpage at 703. A user can select a widget from the one or more widgets for designing the webpage at 704. The user may select the widget through a UI operation (e.g., the drag-&-drop operation). The user can position the selected widgets on various sections of the webpage. The page layout tool 110 identifies various sections (e.g., header, footer, and body) of the webpage and widgets positioned in corresponding sections of the webpage at 705. Once the section and the widgets are identified, the page layout tool integrates the widgets to the corresponding section and to one or more predefined security rules at 706.

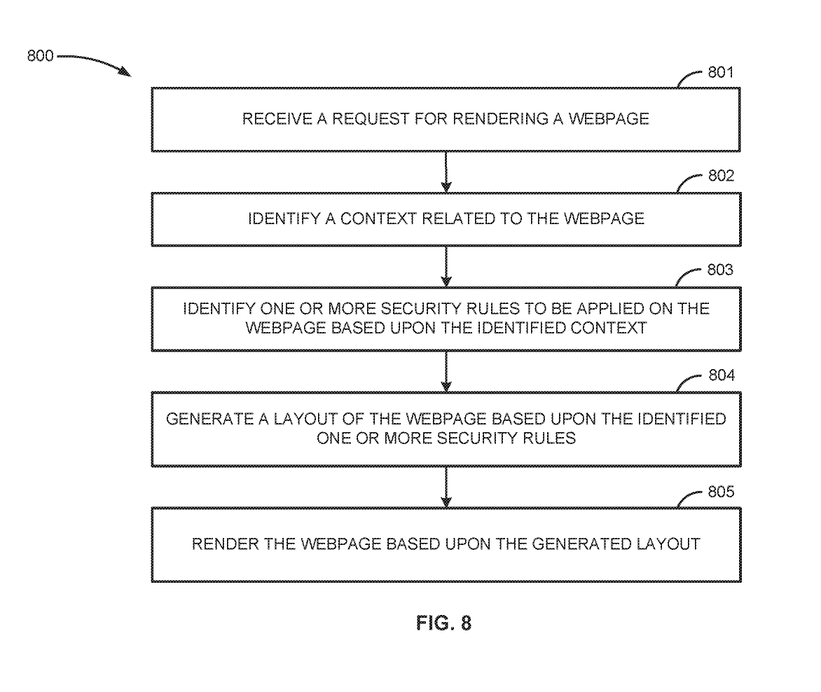

FIG. 8 is a flowchart illustrating process 800 to render the webpage at runtime. At 801, a request may be received for rendering the webpage. The request may be provided through a command such as clicking an icon. At 802, based upon the received request, a context related to the webpage may be identified. The context comprises one or more of a log-in information of a user accessing the webpage, a business role or a designation of the user accessing the webpage, the business process for which the webpage is created, and a business process state. Based upon the identified context, one or more security rules may be identified at 803. A layout of the webpage is generated dynamically based upon the identified one or more security rules (e.g., by applying the security rule upon base template of the webpage) at 804. The base template refers to template of the webpage including all widgets without applying any restrictive rules. At 805, the webpage is rendered based upon the generated layout.

Embodiments enable users (e.g., customers or end users) to design, create, modify, or update webpages dynamically based upon their requirements. The users or customers can easily select widgets (e.g., vendor provided predefined widgets) using UI operations such as drag-&-drop operation to design the webpages. The webpages can be easily created or modified, using basic UI operations, directly on the cloud. The users can design their customized webpages, save it, and reuse it later. Therefore, the embodiments provide an extendable, scalable, and flexible framework for dynamically designing the webpages. The framework allows customers to be creative to experiment with various design options according to their business requirements without contacting vendors and spending money and time. The customers are presented with widgets allowable for their business purposes. In case, a customer tries to use wrong widget in their webpage, an error message may be displayed. Various rules can be configured for widgets so that a widget's behavior changes based upon the configured rules. For example, the widget's behavior may change based upon a nature of the business processes, entity for which the widget is used, log-in information of the user running the webpage, the process state, or business logic, etc. Various predefined rules or security rules may be automatically applied while rendering the webpage at runtime.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices: magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

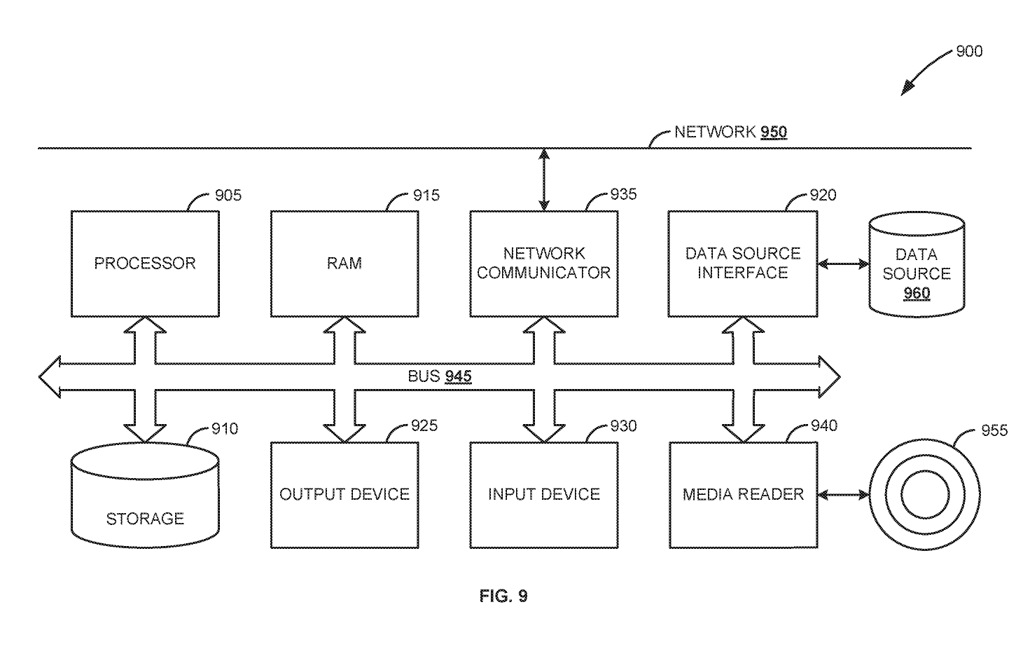

FIG. 9 is a block diagram of an exemplary computer system 900. The computer system 900 includes a processor 905 that executes software instructions or code stored on a computer readable storage medium 955 to perform the above-illustrated methods. The processor 905 can include a plurality of cores. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. According to some embodiments, such as some in-memory computing system embodiments, the RAM 915 can have sufficient storage capacity to store much of the data required for processing in the RAM 915 instead of in the storage 910. In some embodiments, the data required for processing may be stored in the RAM 915. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. The output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

1. A non-transitory computer readable storage medium storing instructions, which when executed by a computer cause the computer to perform operations comprising:
receiving a request for designing a webpage;
based upon the request, identifying a metadata related to the webpage and
rendering a plurality of widgets for designing the webpage;
receiving a selection of widgets from the plurality of widgets for designing the webpage;
upon determining, based upon the identified metadata, that one of the selected widgets is relevant to the webpage, performing the operations comprising:
identifying multiple sections of the webpage and identifying the relevant widget and one or more other widgets positioned in corresponding sections of the webpage; and
integrating the identified relevant widget and the one or more other widgets to the corresponding sections of the webpage and to one or more security rules defined for the webpage;
and
upon determining, based upon the identified metadata, that another widget of the selected widgets is non-relevant to the webpage, displaying an error message.

2. (canceled)

3. The computer readable medium of claim 1, wherein the multiple sections include a header, a footer, and a body of the webpage.

4. (canceled)

5. The computer readable medium of claim 1 further comprising instructions which when executed by the computer cause the computer to:
receive a request for rendering the webpage;
identify a context related to the webpage;
based upon the context of the webpage, identify the one or more security rules to be applied on the webpage;
based upon the identified one or more security rules, dynamically generate a layout for rendering the webpage; and
based upon the generated layout, render the webpage.

6. The computer readable medium of claim 5, wherein the context comprises one or more of a log-in information of a user accessing the webpage, a business role or a designation of the user accessing the webpage, a business process for which the webpage is created, and a business process state.

7. The computer readable medium of claim 1 further comprising instructions which when executed by the computer cause the computer to:
identify an action performed on the webpage;
based upon the action, generate an event and identify one or more widgets to be updated in the webpage; and
send the generated event to the identified one or more widgets, wherein the one or more widgets update its data upon receiving the event.

8. The computer readable medium of claim 7, wherein the action comprises one of addition of data, deletion of data, updating data, and selection of a user interface component on the webpage.

9. A computer-implemented method for dynamically designing webpages, the method comprising:
receiving, by at least one processor, a request for designing a webpage;
based upon the request, identifying, by the at least one processor, a metadata related to the webpage and rendering a plurality of widgets for designing the webpage;
receiving, by the at least one processor, a selection of widgets from the plurality of widgets;
upon determining, based upon the identified metadata, by the at least one processor, that one of the selected widgets is relevant to the webpage, performing the operations comprising:
identifying, by the at least one processor, multiple sections of the webpage and identifying the relevant widget and one or more other widgets positioned in corresponding sections of the webpage; and
integrating, by the at least one processor, the identified relevant widget and the one or more other widgets to the corresponding sections of the webpage and to one or more security rules defined for the webpage;
and
upon determining, based upon the identified metadata, by the at least one processor, that another widget of the selected widgets is non-relevant to the webpage, displaying an error message.

10. The computer-implemented method of claim 9 further comprising:
receiving, by the at least one processor, a request for rendering the webpage;
identifying, by the at least one processor, a context related to the webpage;
based upon the context of the webpage, identifying, by the at least one processor, the one or more security rules to be applied on the webpage;
based upon the identified one or more security rules, dynamically generating, by the at least one processor, a layout for rendering the webpage; and
based upon the generated layout, rendering, by the at least one processor, the webpage

11. The computer-implemented method of claim 10, wherein the context comprises one or more of a log-in information of a user accessing the webpage, a business role or a designation of the user accessing the webpage, a business process for which the webpage is created, and a business process state.

12. The computer-implemented method of claim 9 further comprising:
identifying, by the at least one processor, an action performed on the webpage;
based upon the action, generating, by the at least one processor, an event and identifying, by the at least one processor, one or more widgets of the plurality of widgets to be updated in the webpage; and
sending, by the at least one processor, the generated event to the identified one or more widgets, wherein the one or more widgets update and render its data based upon the received event.

13. The computer-implemented method of claim 12, wherein the action comprises one of addition of data, deletion of data, updating data, and selection of a user interface component on the webpage.

14. A computer system for dynamically designing webpages, the system comprising:
at least one memory to store executable instructions; and
at least one processor communicatively coupled to the at least one memory, the at least one processor configured to execute the executable instructions to:
receive a request for designing a webpage;
based upon the request, identify a metadata related to the webpage and
render one or more widgets for designing the webpage;
receive a selection of at least one widget from the one or more widgets;
based upon the identified metadata, determine whether the selected at least one widget is relevant to the webpage:
upon determining the selected at least one widget is relevant to the webpage, perform the operations comprising:
identify multiple sections of the webpage and identify the selected at least one widget and one or more other widgets positioned in corresponding sections of the webpage; and
integrate the identified at least one widget and the one or more other widgets to the corresponding sections of the webpage and to one or more security rules defined for the webpage;
and
upon determining the selected at least one widget is non-relevant to the webpage, display an error message.

15. (canceled)

16. The system of claim 14, wherein the metadata defines a business process related to the webpage and wherein the multiple sections include a header, a footer, and a body of the webpage.

17. The system of claim 14, wherein the processor is further configured to execute the executable instructions to:
receive a request for rendering the webpage;
identify a context related to the webpage;
based upon the context of the webpage, identify the one or more security rules to be applied on the webpage;
based upon the identified one or more security rules, dynamically generate a layout for rendering the webpage; and
based upon the generated layout, render the webpage.

18. The system of claim 17, wherein the context comprises one or more of a log-in information of a user accessing the webpage, a business role or a designation of the user accessing the webpage, a business process for which the webpage is created, and a business process state.

19. The system of claim 14, wherein the processor is further configured to execute the executable instructions to:
identify an action performed on the webpage;
based upon the action, generate an event and identify one or more widgets to be updated in the webpage; and
send the generated event to the identified one or more widgets, wherein the one or more widgets update and render its data upon receiving the event.

20. The system of claim 19, wherein the action comprises one of addition of data, deletion of data, updating data, and selection of a user interface component on the webpage.

21. The computer readable medium of claim 1 further comprising instructions which when executed by the computer cause the computer to:
receive a request for rendering the webpage;
based upon the context of the webpage, identify the one or more security rules to be applied on the webpage;
based upon the identified one or more security rules, dynamically generate a plurality of layouts for rendering the webpage;
receive a selection of a layout from the plurality of layouts for rendering the webpage; and
based upon the selected layout, render the webpage.

22. The computer readable medium of claim 1, wherein integrating the identified relevant widget and the one or more other widgets to the one or more security rules comprises including the one or more security rules within code of the identified widgets.
